(19) United States
(12) Patent Application Publication
(10) Pub. No.: US 2007/0253366 A1
(43) Pub. Date: Nov. 1, 2007

(54) Process for Assigning Radio Resources Between a Number of Multiplexed Transport Channels in a Physical Channel

(75) Inventors: Frederic Gabin, Bagnolet (FR); Guillaume Delaval, Nogent-sur-Marne (FR)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 11/571,346

(22) PCT Filed: Jul. 1, 2005
(86) PCT No.: PCT/JP05/12620

§ 371 Date: Dec. 27, 2006

(51) Int. Cl. H04Q 7/00

(52) U.S. Cl. 370/329; 370/328

(57) ABSTRACT

The invention concerns a process for assigning radio resources between a number M of multiplexed transport channels in a physical channel, each transport channel carrying a service and/or data having a requirement of a specific QoS between a user terminal and a base station of a cellular telecommunications network. The process of the invention comprises the following steps of: a)—estimating the QoS of each of the transport channels received b)—determining N services among the M services for which QoS is greater than a predetermined target value, c)—reducing the proportion of the physical channel allocated to the N transport channels determined in the step b) by modifying their flow adaptation parameters, d)—waiting for convergence of the power control loop, e)—performing the steps c) and d) until the specific QoS of each channel is attained with minimal transmission power of the physical channel.

The invention consists in the field of telecommunications and concerns more specifically a process for assigning radio resources between a number M of multiplexed transport channels in a physical channel, each transport channel carrying a service and/or data having a specific Quality of Service (QoS) requirement between a user terminal and a base station of a cellular telecommunications network.

The invention concerns also a mobile terminal and a base station adapted for the use of the process.

### BACKGROUND ART

The transmission power of a mobile terminal or a base station in the network of cellular telecommunications is systematically controlled in order to, on one hand, ensure the same quality of service (QoS) for the terminal independently of its position in the network, and on the other hand, increase the autonomy of the battery while avoiding to increase uselessly the level of interference in a cell. This control can be done on the uplink as well as on the downlink.

On the uplink, the base station (“Node B”) measures the present signal to interference ratio (SIR) on the received signal and transmits to the terminal a command in order that the latter adjusts its transmission power. On the downlink, the mobile terminal performs similar operations to the downlink. This power control mechanism where the terminal and the base station adjust mutually their transmission powers is known in CDMA under the name of “Closed-loop power control.”

The commands exchanged between the base station and the terminal in order to adjust their transmission powers are based on the level of an SIR (signal to interference ratio) established by a Radio Network Controller (RNC) in charge of the management of the radio resources in the cells it controls.

The process of power control described here above can be represented by two processing loops, schematically illustrated in FIG. 1, in which measures of quality of service and commands of power adaptation are executed simultaneously.

The first processing loop, called internal loop, executes a rapid processing to adjust the power of the signal received by the terminal or by the base station in order to maintain the signal to interference radio (SIR) equal to a target SIR_{c} value predetermined by the second loop.

The second loop, called external loop, has the function to define the signal to interference ratio SIR_{c} in order to maintain the block error rate (BLER) measured on the transport blocks of the received signal at a target value BLER_{c}, ensuring the quality of service at the required level.

As illustrated in FIG. 1, the internal loop comprises an adapted filter 2, a RAKE receiver 4, a module 6 for calculating the signal to interference ratio (SIR) and a module 8 for producing command bits (TPC, for Transmit Power Control).

The external loop comprises in addition to the adapted filter 2 and RAKE receiver 4, a channel decoder 10, a module 12 for detecting block errors and a module 14 for comparing the BLER with the target BLER_{c} value to update the SIR_{c}.

The module 6 calculates the present SIR relative to a received signal and transmits the calculated SIR to module 8 which produces a bit “0” if the calculated SIR is greater than the SIR_{c} target value, or a bit “1” if the calculated SIR is smaller than SIR_{c}.

The estimation of SIR_{c} is based on a measure of the link quality in terms of BLER. The optimal value of SIR_{c} must be such that the desired link quality is achieved with the minimal transmission power of the base station or the mobile terminal. If the estimated quality is higher than the target one, the SIR_{c} value is reduced, and in the opposite case, the value is increased.

In the UMTS UTRA system, it is possible to multiplex several services with different quality of service (QoS) requirements on only one physical channel. During the communication, the control executed by the external loop adjusts dynamically the target signal to interference ratio SIR_{c} in order to maintain, for each service carried via the physical channel, the block error rate BLER measured on the blocks carrying the received signal at a target value BLER_{c}. Now, there can be only one target value for the rapid control of power on a closed loop because all the services have a common power control. This target signal to interference ratio SIR_{c} is defined according to the service requiring the highest SIR_{c}. Thereby, the transmission power required to attain this target signal to interference ratio SIR_{c} can be overestimated for the other multiplexed services which require a lower SIR_{c}.

It follows from this an unbalance between the real power requirement of the service transport channels and the power really available for these channels.

This power unbalance has the effects of, on one hand, increasing the interference level for the other system users, and on the other hand, limiting the life of the terminal battery.

It is an object of the invention to rebalance the assignment of the radio resources between the different transport channels by selectively adapting their coding parameters in order to reduce the transmission power through the physical channel while respecting the requirements of QoS for all the services transmitted through this channel.

### DISCLOSURE OF INVENTION

The invention proposes a process for assigning radio resources between a number M of multiplexed transport channels in a physical channel, each transport channel carrying a service and/or data having a requirement of a specific quality of service (QoS) between a user terminal and a base station of a cellular telecommunications network.

The process of the invention comprises the following steps:

a)—estimating the quality of service (QoS) of each of the transport channels received,

b)—determining N services among the M services for which the QoS is greater than a predetermined target value,

c)—reducing the proportion of the physical channel allocated to the N transport channels determined in the step b) by modifying their flow adaptation parameters,

d)—waiting for convergence of the power control loop,

e)—executing the steps c) and d) until the specific QoS of each channel is attained with minimal transmission power of the physical channel.

This process comprises also the step during which, for each transport channel, the signal to interference ratio (SIR) is estimated and the transmission power is set so as to attain the optimal target signal to interference ratio (SlR_{co}) ensuring the QoS required for each transport channel while minimizing the transmitted power.

Preferably, the reduction of the transmission flow in the transport channels for which the QoS is greater than a predetermined target value is achieved by modification of a flow adaptation parameter predetermined for each transport channel.

The process of the invention is preferably used in a UMTS cellular network. In this case, the flow adaptation parameter is the RM (Rate Matching) parameter defined in Specification TS25.212.

The invention concerns also a mobile terminal capable of exchanging with a base station, via one physical channel, a plurality of services and/or data each having a requirement of a specific QoS. This terminal includes means for adapting dynamically and selectively the data flow of a part of the services less demanding in terms of QoS in order to reduce the transmission power without degradation of the quality of the services more demanding in terms of QoS.

The invention concerns also a base station of a cellular telecommunications network capable of exchanging with a mobile terminal, via one physical channel, a plurality of services and/or data each having a requirement of a specific QoS. This base station includes means for adapting dynamically and selectively the data flow of a part of the services less demanding in terms of QoS in order to reduce the transmission power without degradation of the quality of the services more demanding in terms of QoS.

### BRIEF DESCRIPTION OF DRAWINGS

Other characteristics and advantages of the invention will appear through the following description, taken as a non-limiting example, with reference to the attached figures in which:

FIG. 1, described above, illustrates schematically two power control loops of the prior art.

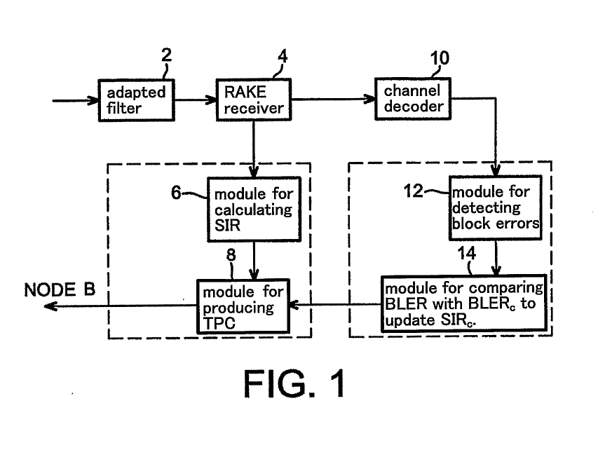

FIG. 2 represents a general flow chart illustrating the process of the invention.

FIG. 3 represents an example of embodiment of the process of the invention.

### BEST MODE FOR CARRYING OUT THE INVENTION

The following description concerns the use of the process in a UMTS cellular network in which a mobile terminal, linked to a base station, receives, through one physical connection, four distinct services with distinct quality of service QoS requirements, such as a vocal service, a video service, a data service and an Internet connection. These services are carried by four distinct transport channels TrCH1, TrCH2, TrCH3 and TrCH4 multiplexed in the same physical channel linking the base station and the terminal.

Once the mobile terminal has established communication with the base station, the power control in closed loop is activated. On the uplink, the base station measures continually the quality of the signal in terms of signal to interference ratio (SIR) and sends a command to the terminal on the downlink channel requesting an increase of transmission power if the measured SIR is smaller than the target value SIR_{c}, or a reduction of the transmission power if the measured SIR is greater than the target value SRC.

On the downlink, the rapid adjustment of the target value is done by power control on the external loop at the level of the mobile terminal.

The internal loop executes a rapid processing to adjust the power of the signal received by the terminal or the base station in order to maintain the signal to interference ratio (SIR) equal to a predetermined target value SIR_{c} through the external loop. The latter determines the target signal to interference ratio SIR_{c} so as to maintain the block error rate (BLER) measured on the transport blocks of the signals received via each of the transport channels TrCH1, TrCH2, TrCH3 et TrCH4 at a target value BLER_{c}.

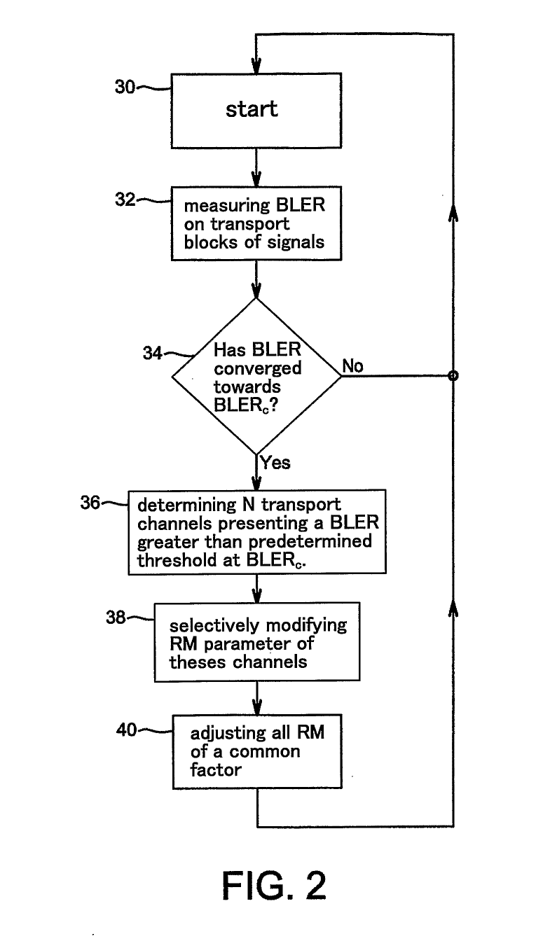

FIG. 2 indicates schematically the steps of the process of the invention to adapt the flow adaptation parameters allowing for minimizing the transmission power while ensuring the quality of service desired for each of the transport channels TrCH1, TrCH2, TrCH3 and TrCH4.

Step 32 consists in measuring the block error rate (BLER) on the transport blocks of the signals received via each of the transport channels TrCH1, TrCH2, TrCH3 and TrCH4.

Step 34 consists in verifying if the BLER measured for each of the transport channels TrCH1, TrCH2, TrCH3 has at least reached the target BLER_{c} determined for each of these channels.

If the measured BLER has not converged towards the target BLER_{c}, the process is resumed from step 32.

If the measured BLER has converged towards the target BLER_{c}, the process continues to step 36 which consists in determining the N transport channels presenting a BLER greater than the predetermined threshold at the target value BLER_{c}.

Step 38 consists in selectively modifying the RM (Rate Matching) parameter of theses channels to allow reduction of the transmission power while still ensuring the target value BLER_{c} for each of the transport channels.

Step 40 consists in adjusting all the RM of a common factor if at least one value of the modified RM is under the minimal normalized RM. The common factor is selected to ensure that all the RM values are included between the minimal and maximal normalized values.

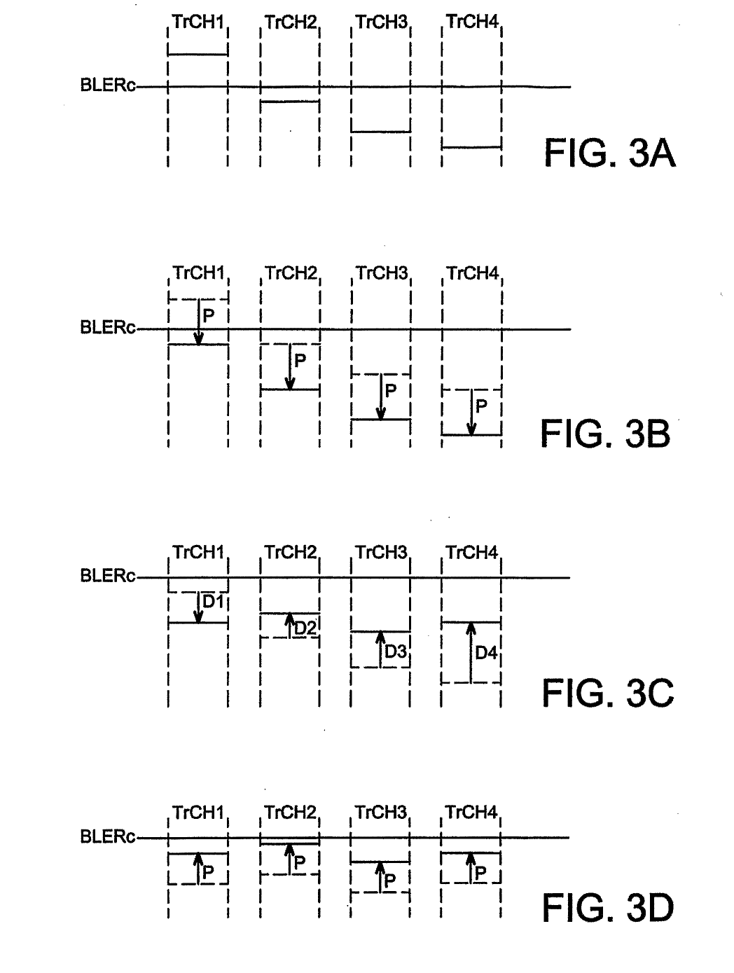

FIG. 3 presents schematically the evolution of the BLER of the four transport channels TrCH1, TrCH2, TrCH3 and TrCH4 compared with their target value BLER_{c} according to the update of the flow adaptation parameters, as well as the SIR_{c}.

To simplify the explanation, we suppose that the target value BLER_{c} is identical for all the transport channels.

In FIG. 3A, the TrCH1 channel presents a BLER value for which the service carried via this channel has a quality of service inferior to the target QoS, and each of the TrCH2, TrCH3 and TrCH4 channels present a BLER value for which the service carried via this channel has a quality of service superior to the target QoS.

To attain the target quality of service of TrCH1, the transmission power is increased (arrow P in FIG. 3B) for all the transport channels.

This power increase is uselessly reflected on the TrCH2, TrCH3 and TrCH4 channels which had already a sufficient quality of service.

To be able to reduce the transmission power without degradation of the quality of channel TrCH1, the parameter RM (arrows D2 to D4 in FIG. 3C) of the channels TrCH2, TrCH3 and TrCH4 is selectively decreased, which has the effects of automatically reducing the proportion of the flow of the physical channel allocated to the channels TrCH2, TrCH3 and TrCH4 and automatically increasing the proportion of the flow of the physical channel allocated to channel TrCH1. This has the consequence of increasing the BLER of the channels TrCH2, TrCH3 and TrCH4 and reducing the BLER of channel TrCH1 (arrow D1 in FIG. 3C).

This results in a rebalance of the QoS between on one hand the channel TrCH1, and on the other hand the channels TrCH2, TrCH3 and TrCH4. The decrease of the power (arrow P in FIG. 3D) is then possible while still ensuring the quality of service of channel TrCH1.

1. A process for assigning radio resources between a number M of mulitplexed transport channels in a physical channel, each transport channel carrying a service and/or data with a requirement of a specific quality of service (QoS) between a user terminal and a base station of a cellular telecommunications network, said process comprising the following steps of:
a)—estimating the QoS of each of the transport channels received,
b)—determining N services among the M services for which the QoS is greater than a predetermined target value,
c)—reducing a proportion of the physical channel allocated to N transport channels determined in the step b) by modifying their flow adaptation parameters,
d)—waiting for convergence of a power control loop,
e)—performing the steps c) and d) until the specific QoS of each service is reached with minimal transmission power of the physical channel.

2. The process according to claim 1, characterized in that said process further comprises the step during which, for each transport channel, a signal to interference ratio (SIR) is estimated and the transmission power is set so as to reach an optimal target signal to interference ratio (SIR_{co}) guaranteeing the QoS that is required for each one of the transport channels, while minimizing transmitted power.

3. The process according to claim 1, characterized in that the step c) is carried out by modifying a predefined flow adaptation parameter for each transport channel.

4. The process according to claim 3, characterized in that the cellular network is a UMTS net work.

5. The process according to claim 4, characterized in that said flow adaptation parameter is a Rate Matching (RM) defined in specification 3GPP TS 25.212.

6. A mobile terminal capable of exchanging with a base station, via a single physical channel, a multitude of services and/or data each having a requirement of a specific quality of service (QoS), characterized in that said mobile terminal comprises:
a)—means for estimating the QoS of each of transport channels received,
b)—means for determining N services among the M services for which the QoS is greater than a predetermined target value,
c)—means for reducing a proportion of the physical channel allocated to N transport channels determined in the step b) by modifying their flow adaptation parameters until the specific QoS of each service is reached with minimal transmission power of the physical channel.

7. A base station of a cellular telecommunications network capable of exchanging with a mobile terminal, via a single physical channel, a multitude of services and/or data each having a requirement of a specific quality of service (QoS), characterized in that said base station comprises:
a)—means for estimating the QoS of each of transport channels received,
b)—means for determining N services among the M services for which the QoS is greater than a predetermined target value,
c)—means for reducing a proportion of the physical channel allocated to N transport channels determined in the step b) by modifying their flow adaptation parameters until the specific QoS of each service is reached with minimal transmission power of the physical channel.
